(19) United States
(12) Patent Application Publication
(10) Pub. No.: US 2010/0035029 A1
(43) Pub. Date: Feb. 11, 2010

(54) Distortion Resistant, High-Definition Litho Applique

(76) Inventors: Harvey NGO, Toronto (CA); Hyman NGO, Toronto (CA); Hilton NGO, Markham (CA)

Correspondence Address: MARKS & CLERK, P.O. BOX 957, STATION B, OTTAWA, ON, K1P 5S7, CA

(21) Appl. No.: 12/537,489

(22) Filed: Aug. 7, 2009

Related U.S. Application Data
(60) Provisional application No. 61/087,889, filed on Aug. 11, 2008.

(30) Foreign Application Priority Data
Oct. 9, 2008 (CA) 2639555

(51) Int. Cl. B32B 3/10; B44C 1/17; B32B 7/08

(52) U.S. Cl. 428/196; 156/234; 156/93

(57) ABSTRACT

A process for creating and applying a soft, high-definition, complex shaped appliqué such that the shape of the appliqué is not distorted when stitched onto a garment and the appliqué can optionally be embroidered without requiring additional alignment processes. The appliqués are made by sublimating a high-definition image onto an upper fabric capable of retaining the high-definition image, affixing the upper fabric to a soft backing fabric capable of resisting dimensional distortion, and then laser cutting the complex shape such that the resulting appliqué can be stitched onto a garment.

### CROSS-REFERENCE TO RELATED APPLICATIONS

This application claims the benefit of U.S. Provisional Application No. 61/087,889 filed Aug. 11, 2008 under 35 USC 119(e), the contents of which are incorporated by reference herein.

### FIELD OF THE INVENTION

The present invention relates to a process for making high definition appliqués and emblems for garments and other material items. More specifically, the present invention relates to high definition litho and emblems and processes for producing the same.

### BACKGROUND OF THE INVENTION

In the textile arts there are many methods and processes for decorating and/or personalizing fabric including, for example, appliqué, silk-screening, and decorative stitching.

Generally, appliqué involves placing or laminating a first fabric layer over a second fabric layer and securing the first layer in place. Various methods of adhering the first and second fabric layers are known in the art and include sewing or basting the first layer to the second layer, or the use of adhesive material.

Modified appliqués and methods of making the same are known in the art and include methods of making screen printed appliqués as disclosed in U.S. Pat. No. 6,955,124 and methods of making sublimated and screen printed appliqués as disclosed in U.S. Pat. No. 7,410,932.

High-definition images such as photographs or digitally created images can be transferred to garments using thermal transfer, direct to garment, or sublimation transfer printing technology, however, these techniques have significant limitations and drawbacks for widespread use in a commercial environment. For example, in order to achieve 150 dpi or higher resolution images while maintaining an acceptable feel to the finished product, the garment must be fabricated from high-cotton content fabrics or specially treated fabrics, while in order to achieve resolution higher than 300 dpi the fabric must have a structure and density capable of retaining the resolution. Other fabric types require increased volumes of ink in order to form a layer on the garment capable of retaining the required image resolution resulting in a product having a leathery, and commercially unacceptable feel. Another drawback of these techniques is that different processes are required to print the same image on garments of different colours. For example, printing the image of a sunset on a white t-shirt instead of a black or blue t-shirt would require different colour and ink volume adjustments in order to produce an image that looked the same on each t-shirt.

All of these limitations narrow the commercial appeal of directly transferring high resolution images onto garments.

Using a different technique, WO 2007103168 describes a process for creating digital appliqués having the appearance of being stitched or embroidered, and then affixing them to garments using adhesive backings. While this technique attempts to create high resolution images on appliqués, there are three drawbacks. First, appliqués affixed using only adhesives suffer from separation at the edges after being worn and washed multiple times. Second, complex shaped appliqués such as words cut out of a high-resolution digital image, are difficult to apply to a garment in a commercial environment while maintaining the dimensional accuracy of the letters in the words. That is, for a word such as VAIL, being cut out of an image of a ski resort, special manual alignment of the segments of the letters is required prior to the adhesion process in order to maintain an acceptable appearance of the overall word. Third, true embroidery cannot be accurately added to the appliqué once it is affixed to the garment without either ensuring that the alignment step described above meets dimensional tolerances to within 1 or 2 mm, or having to modify the embroidery pattern for each individual garment in order to adapt to the potential distortion experienced by the appliqué during the adhesion process. Additionally, the garment with appliqué requires an additional alignment step when the garment is transferred from the adhesion step in the process to the embroidery step.

### SUMMARY OF THE INVENTION

Generally disclosed is a process of creating high definition litho appliqués and emblems and processes for producing the same. Embodiments of the invention aim to provide a high-definition, digitally printed, complex shaped appliqués that are soft and comfortable to wear and can be applied to a wide range of garment fabrics while also being resistant to dimensional distortion in order to eliminate the need for manual adjustments during the cutting, stitching and embroidery manufacturing processes, making the overall process commercially viable.

Broadly in one aspect of the present invention, there is provided a method for manufacturing high definition litho appliqué comprising digitally printing a high resolution image onto transfer paper; transferring the image to an appropriate fabric to obtain an imaged fabric; and cutting out the image from the imaged fabric to obtain a high definition litho appliqué. Optionally, the appliqué is a limited edition appliqué. The limited edition appliqué may be either a numbered or open series limited edition. In accordance with one embodiment of the invention, the method further comprises attaching the high definition litho appliqué to a garment.

In accordance with another aspect of the invention, there is provided a method for manufacturing a garment or hat with high definition litho emblem comprising digitally printing a high resolution image onto a transfer substrate; transferring the image to an appropriate fabric to obtain an imaged fabric; cutting out the image from the imaged fabric to obtain a cut out printed design; cutting out a felt backing for the cut out printed design; and applying the cut out printed design and felt backing to a garment or hat.

The transfer substrate will normally be paper, although any suitable substrate could be used for transferring the inks. The use of sublimation inks permits a very high resolution image to be obtained when combined with a suitable fine weave, normally less than 150 denier.

In accordance with another aspect of the invention, there is provided a high definition litho appliqué or emblem manufactured from appropriate fabric, which has been sublimated with a high definition photograph-quality print. In accordance with one embodiment, the appliqué or emblem has the sheen of standard sport twill. Optionally, the appliqué or emblem is a limited edition appliqué or emblem.

In accordance with another aspect of the present invention, there is provided a method for manufacturing high definition litho appliqué comprising digitally printing a high resolution image onto an appropriate fabric to obtain an imaged fabric; and cutting out the image from the imaged fabric to obtain a high definition litho appliqué. In accordance with one embodiment of the invention, the method further comprises attaching the high definition litho appliqué to a garment.

In accordance with an aspect of the present invention, there is provided a method of making a pliable high definition appliqué, comprising: (i) digitally printing a high resolution image onto a transfer substrate using sublimation inks; (ii) pre-heating a swatch of woven fabric made of twill or microfiber having a denier of less than 150 to obtain an image-ready pre-shrunk swatch of woven fabric; (iii) forming said image on said swatch by applying said transfer substrate under applied heat and pressure to a front side thereof so as to transfer said sublimation inks to said swatch; and (iv) cutting out the image from the imaged fabric to obtain the high definition appliqué ready for stitching on to a garment. A pliable stabilizing layer is applied under heat and pressure to a back side of said swatch to stabilize said image against dimensional distortion. It will be understood that this step can be performed either in conjunction with step iii) or following step iii) or prior to step iv) cutting the image out.

Optionally the method may include stitching the high definition litho appliqué onto a garment and/or embroidering a pattern onto the garment and/or high definition litho appliqué. Optionally, a thermo-adhesive film is affixed to the backing of the imaged fabric instead of a fusible backing fabric to obtain a fusible imaged fabric.

As the appliqué is mainly stitched to the underlying garment, it does not lose its flexibility and when applied has a soft feel. In both cases, the backing layer should be pliable and of sufficient flexibility to conform to movement of the underlying garment. This is possible since it is not the primary means of attachment to the garment.

Optionally, the appliqué is a limited edition appliqué. The limited edition appliqué may be either a numbered or open series limited edition. In accordance with one embodiment of the invention, the method further comprises attaching the high definition litho appliqué to a garment.

With the foregoing in mind, it is an object of embodiments of this invention to provide a commercially viable process for creating and affixing to garments appliqués bearing high resolution images. Further, these appliqués can be affixed to a wide range of garment fabrics, can be embroidered without requiring additional alignment steps, result in a garment having an acceptably soft and comfortable feel, and the appliqués are dimensionally accurate as compared to the original image from which they were created.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1 is a schematic diagram illustrating the system which makes the high definition litho appliqué in accordance with one embodiment of the invention;

FIG. 2 is a flow chart depicting one embodiment of the method of making high definition litho appliqué;

FIGS. 3A to 3F are photographic representations of the method of making high definition litho appliqué shown in FIG. 2;

FIG. 4 is a flow chart depicting one embodiment of the method of making high definition litho emblems;

FIG. 5 is a schematic diagram illustrating the system which makes the high definition litho appliqué in accordance with one embodiment of the invention;

FIG. 6 is a flow chart depicting one embodiment of the method of making high definition litho appliqué.

FIG. 7 is a word-art appliqué cut out in the shape of a rectangle;

FIG. 8 is a word-art appliqué cut out in the outline of the lettering;

FIG. 9 is a word-art appliqué cut out in the outline of the lettering showing a first pass stitching path;

FIG. 10 is a word-art appliqué cut out in the outline of the lettering showing a second pass stitching path.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

As mentioned above, embodiments of the present invention provide a method of producing high definition litho and emblems and includes processes for embedding a photograph or pattern onto a twill or micro fiber appliqué such that the sheen of standard sport twill is maintained. The resulting high definition litho appliqué and emblems can optionally be applied to garments or other items.

Other embodiments further provide high definition litho appliqué and emblems manufactured from appropriate fabric, such as 100% polyester twill or micro fiber material, which has been sublimated with a high definition photograph-quality print. The high definition litho appliqué and emblems are cut into the desired shape and optional affixed to a garment. Optionally, the high definition litho appliqué is in the shape of standard athletic sport lettering. The design can include any high resolution images including images of people, organizations, companies, teams, animals, landmarks, events including entertainment and/or sporting events, etc. Optionally, the design may incorporate a logo and/or trademark. Alternatively, a logo and/or trademark may be applied to the garment separately and optionally at a location distinct from the design. The logo and/or trademark may be representative of the people, organizations, teams, landmarks and/or events illustrated in the design's high resolution image.

In one embodiment, the logo and/or trademark are stitched into the fabric of the garment to which the high definition litho appliqué is affixed. Optionally, the stitching of the logo and/or trademark at least partial affixes the high definition litho appliqué to the garment.

In one embodiment of the invention, the high definition litho appliqués and/or emblems are produced in a limited edition with each high definition litho appliqué and/or emblem in the limited edition series assigned a unique number which is printed into the design. Optionally, the numbering is digitally integrated into the design using software capable of a variable data technique. The resulting limited edition high definition litho appliqué or emblem is optionally applied to a garment or other wearable items to form a collectable wearable or collector-targeted memorabilia article. The limited edition appliqué may be either a numbered or open series limited edition.

Optionally, the collectable wearable or collector-targeted memorabilia article is package with an authentication statement and/or other confirmation of the limited edition status.

In one embodiment, the authentication statement and/or other confirmation of limited edition status is affixed to or is integral with the collectable wearable and is optionally a component of a label.

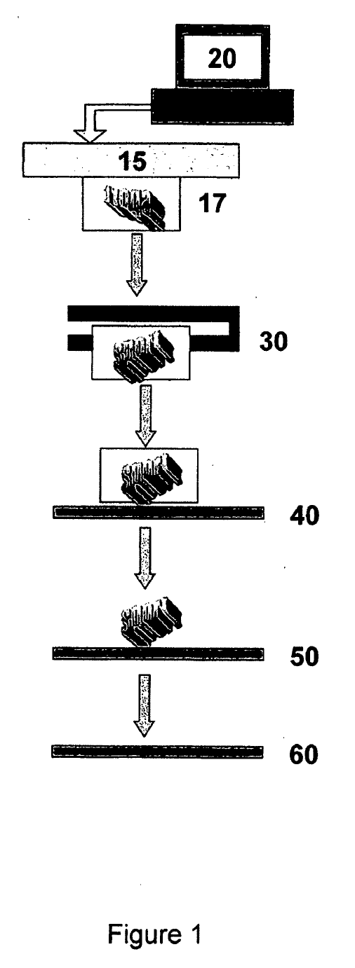

FIG. 1 schematically illustrates a system (10) for making high definition litho appliqué in accordance with one embodiment of the invention. The system (10) comprises an appropriately programmed computer (20) for preparing the design and a plotter (15) such as a wide format ink jet plotter to digitally print the reverse image using sublimation inks onto a transfer paper (17), a heat transfer machine (30) to transfer the image to appropriate fabric, scanner (40), flatbed laser cutter (50) and optionally an embroidery machine (60).

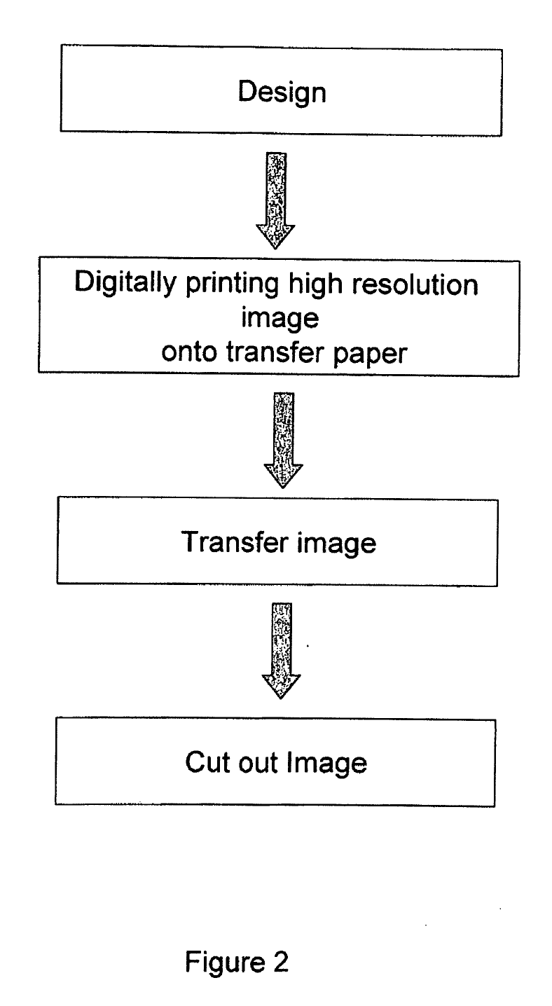

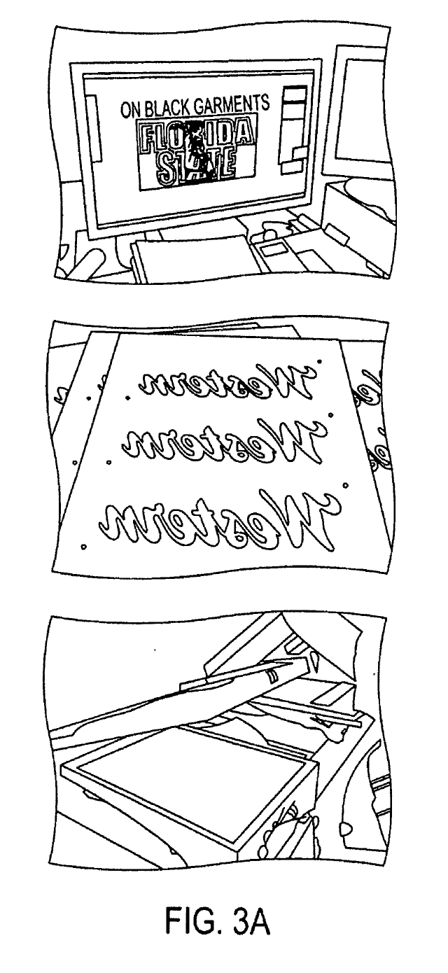

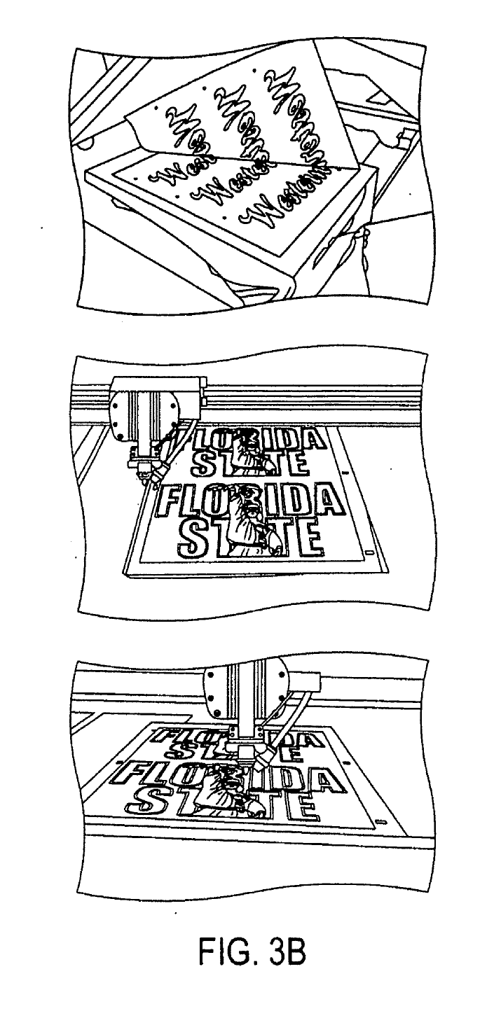

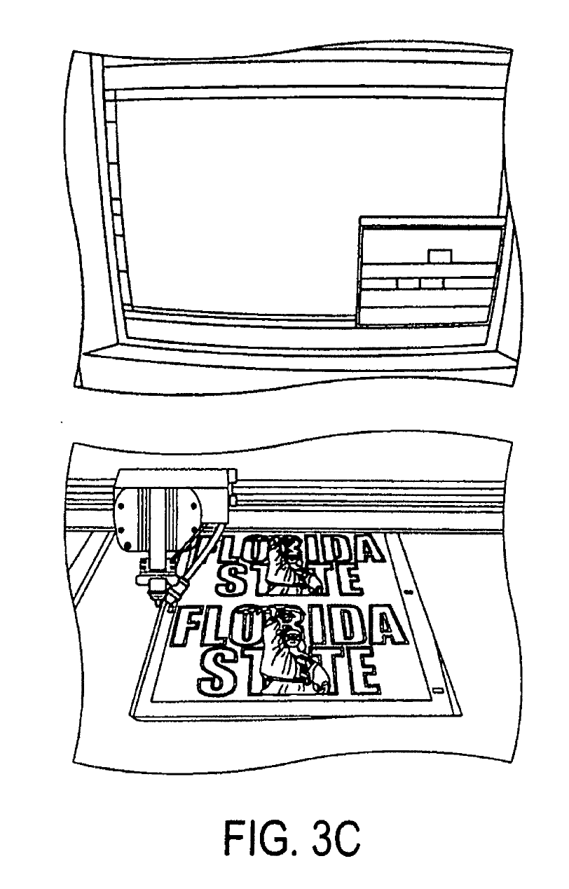

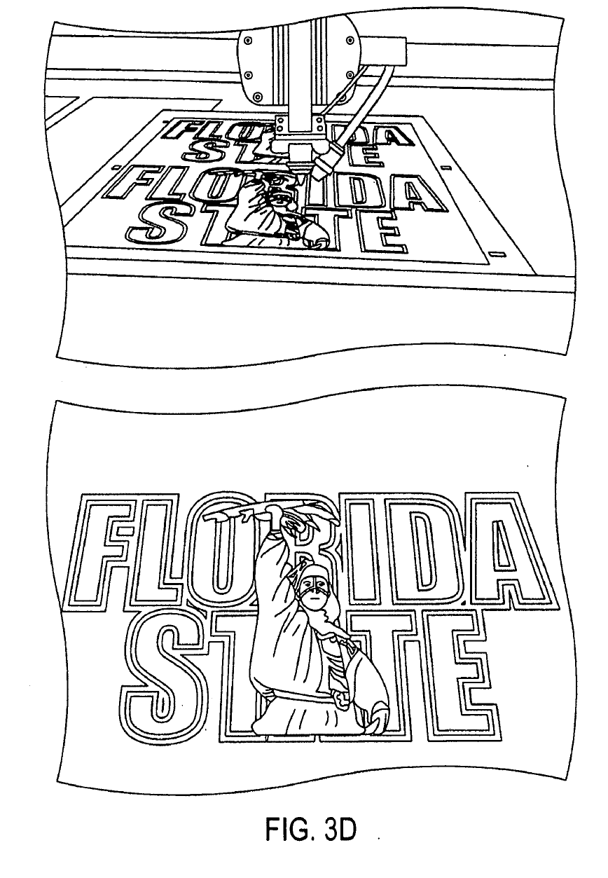

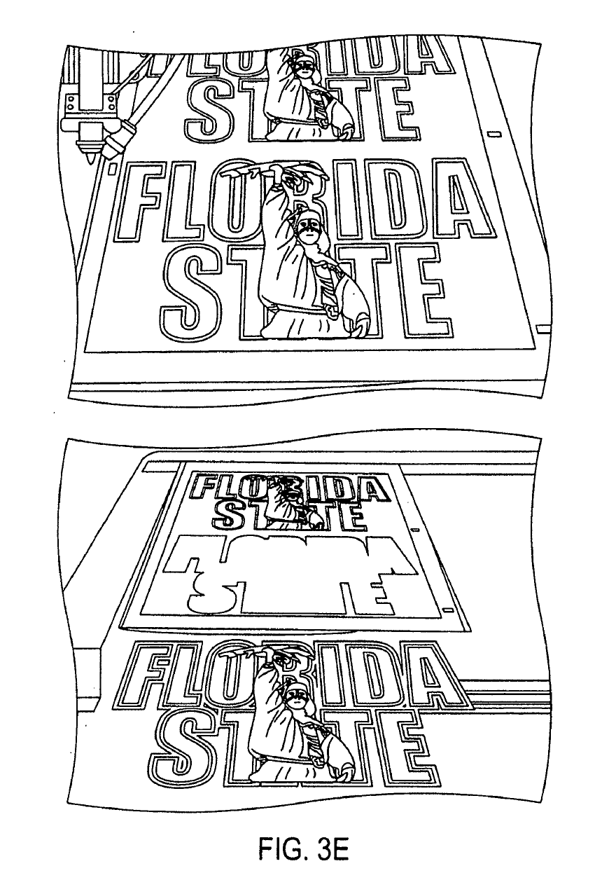

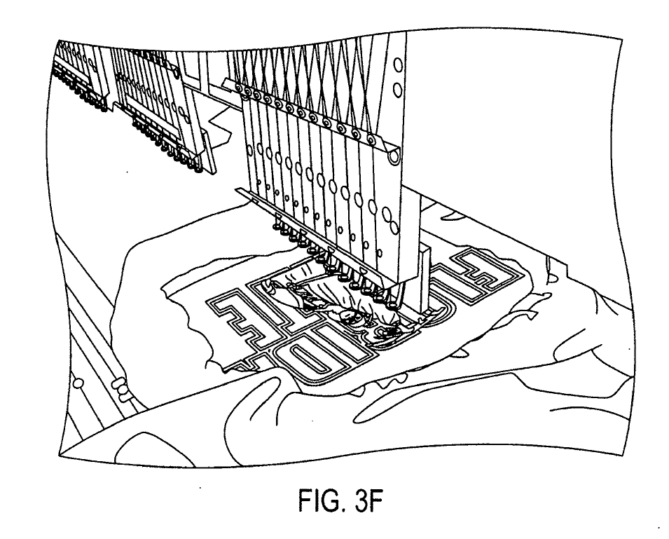

FIGS. 2 and 3A-3F illustrate one method of producing high definition litho appliqué using the system shown in FIG. 1. As shown, high resolution images are formed into the Branding or logo design using an appropriately programmed computer. The reverse image of the final design is digitally printed using sublimation inks onto transfer paper. Appropriate printers, inks and transfer papers are known in the art and are available from various suppliers including Sawgrass Technologies amongst others. Optionally, wide format inkjet plotters can be used.

The printed transfer paper is then imaged onto white 100% polyester twill or micro fiber fabric at about 400 to about 425 degrees Fahrenheit for about 25 to about 35 sec. using a heat transfer machine. Optionally, at the same time, a high temperature backing can be applied to the back of the fabric for stability.

In one optional embodiment, the imaged fabric is then scanned into the computer to create two files. The first file is the cut file to be used on a flatbed laser cutter. The second file is the digitized file used on an embroidery machine to sew the cut design on the garment. The imaged fabric is then accurately cut using the flatbed laser machine with a camera that will recognize a shape. Alternatively, the image may be cut out using a variety of other methods known in the art including die cutting, hand cutting and waterjet cutting. This procedure produces the appliqué, which is now ready to be affixed to a garment. The final step is to sew the appliqué on to the garment using a commercial embroidery machine. Alternatively, the appliqué can be affixed to the garment using other means known in the art. The advantage of scanning the imaged fabric is that the scanned image takes into account any shrinkage resulting from the application of the image onto the fabric.

In one embodiment, in addition to affixing the appliqué to the garment, the stitching forms an integral part of the look and design of the final product. In such embodiments, in addition to being on the perimeter of the appliqué, stitching can be used to pick out or highlight details from the high definition image, add design elements, logos, trademarks and/or lettering. Optionally, the stitching may be in multiple colors, thickness, patterned or textured.

In one embodiment, the appliqué is sewn down strategically using zig zag stitching pattern. To create the rich look of an appliqué, the zig zag pattern is sewn on around each letter or branding to an accuracy of about 1 mm.

In one embodiment, the appliqué is sewn down strategically using a stitching pattern that is more complicated than standard zig zag stitching achieved by manual means.

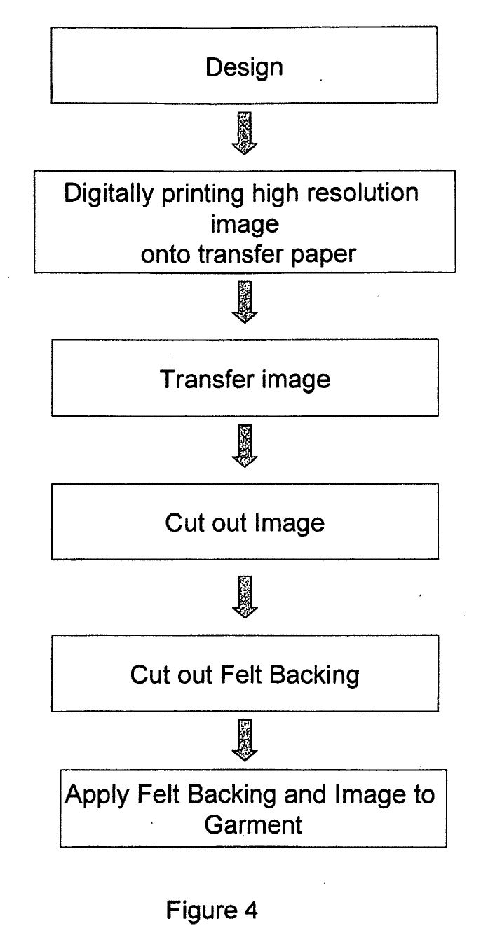

FIG. 4 illustrates one method of producing high definition litho emblems. The desired design is printed using a digital ink jet printer with dye-sublimation CMYK inks on sublimation paper. The design is then transferred using a high heat; high-pressure heat press on to a 100% polyester twill or micro fiber substrate. Using a laser cutter equipped with a magic eye technology or die cut the printed polyester twill or micro fiber material is precisely cut out. A piece of felt that is 2 mm larger than the cut out printed design is cut out using a laser cutter or die cutter. The felt with the printed twill or micro fiber material is applied onto hats or other garments using an embroidery machine.

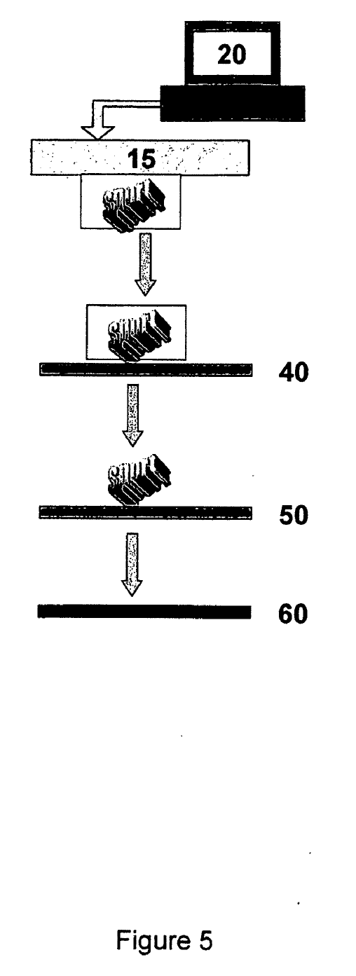

FIG. 5 schematically illustrates a system (10) for making high definition litho appliqué in accordance with one embodiment of the invention. The system (10) comprises an appropriately programmed computer (20) for preparing the design and a plotter (15) such as a wide format inkjet plotter to digitally print the image on to appropriate fabric, a scanner (40), flatbed laser cutter (50) and optionally an embroidery machine (60).

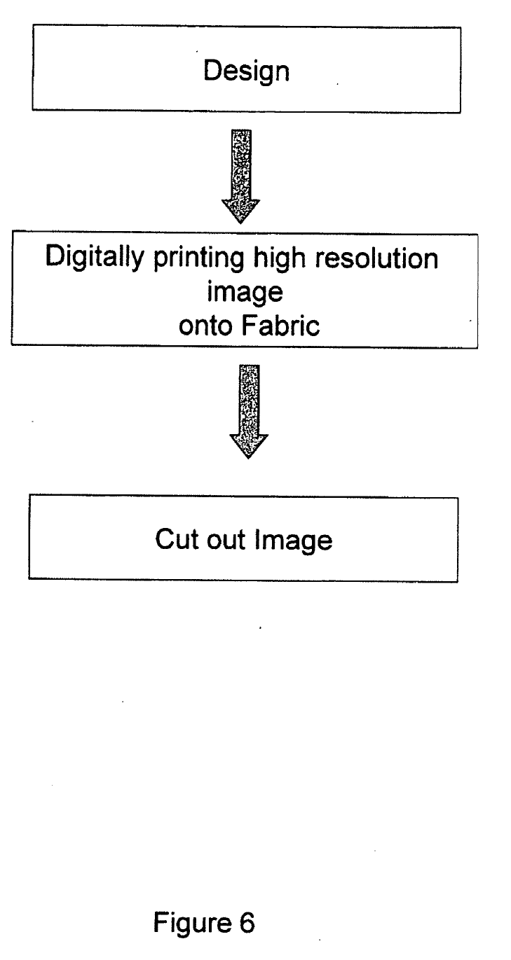

FIG. 6 illustrates one method of producing high definition litho appliqué using the system shown in FIG. 5. As shown, high resolution images are digitally printed onto white 100% polyester twill or micro fiber fabric. The imaged fabric is then scanned and cut out as described above to produce the appliqué, which is now ready to be affixed to a garment.

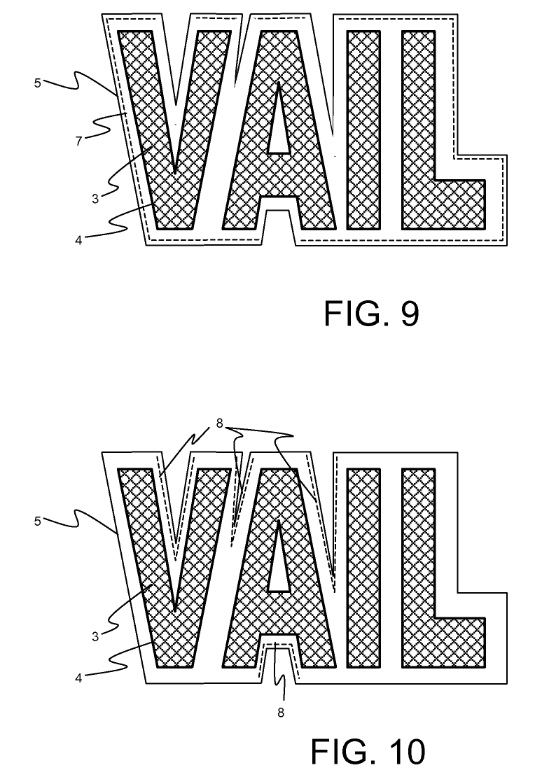

Preferred embodiments of the present invention will now be described with references made to FIG. 7 to 10.

The particular appliqués shown in FIGS. 7 to 10 are just two examples of the shapes of appliqués that can be created using this invention. It should be understood that many other shapes other than rectangular, and that many other word-art forms other than VAIL, are included within the intended scope of the present invention. It should also be understood that in place of word-art, images of different shapes might be used to create an appliqué.

The preferred materials used for the image-ready fabric are either uncoated polyester sport twill or microfiber sheets of 100% sueded polyester satin, 135 gms per sq. meter. The preferred material for the fabric backing is a high temperature non-woven fusible backing. The preferred material for the adhesive film is a 1 g/cc thermo-adhesive film. A suitable film is made Fait Plast, Italy (www.faitplast.com <http://www.faitplast.com>) and sold under the trade name FAITERM 110F™. However, it should be understood that other materials might be used for some or all of the components without departing from the intended scope herein.

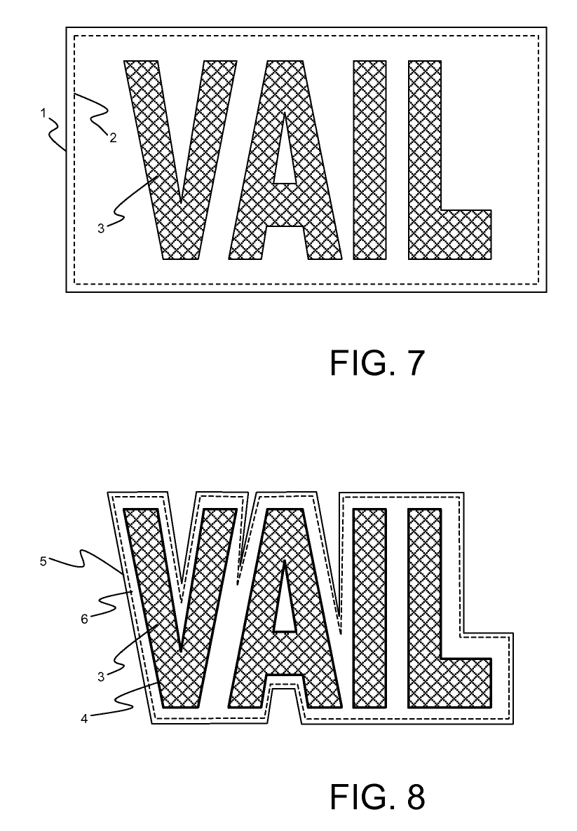

Referring to FIG. 7, a word-art appliqué cut out in the shape of a rectangle 1 is shown. Referring to FIG. 8, a word-art appliqué cut out in the outline of the lettering 5 is shown.

In order to produce an appliqué as shown in either FIG. 1 or 2, having a 150 dpi image within the word-art, the following steps are used:
1. A digital image having resolution greater than 150 dpi, such as from a camera, is brought into a computer program such as Adobe Illustrator;
2. A word-art mask in the form of the word VAIL 3 and having an outer border either in the shape of a rectangle 1 or outline of the word VAIL 5, is created in Adobe Illustrator, and applied to the digital image to produce a digital appliqué image having high-resolution image only inside the letters of the word VAIL 3;
3. The digital appliqué image is then processed by a computer program such as ONYX PosterShop in order to re-calibrate the colors to match the printer's capabilities, and optionally to create a numbered open series limited edition image, which is then printed onto thermal transfer paper using sublimation inks;
4. The digital appliqué image is also processed by another computer program to create digital computer files for laser cutting and optionally for embroidery;
5. A swatch of uncoated polyester sport twill fabric is then heated for 20-30 seconds at 300-350° F. on a heat transfer press to obtain a pre-shrunk swatch of uncoated polyester sport twill;
6. A swatch of high temperature non-woven fusible fabric is placed on a heat transfer press with the adhesive side up;
7. The pre-shrunk swatch of uncoated polyester sport twill fabric is placed on top of the high temperature non-woven fusible fabric;
8. The printed transfer paper is placed on top of the uncoated polyester sport twill fabric with the ink side of the transfer paper in contact with the uncoated polyester sport twill fabric;
9. Heat is applied at 400-425° F. for 20-25 seconds to obtain an imaged fabric which is highly resistant to dimensional distortion;
It should be understood that optionally the image could be heat transferred onto the uncoated polyester sport twill fabric in a first step, followed by the fusing of the high temperature non-woven fusible fabric onto the imaged uncoated polyester sport twill fabric in a second step to obtain the same imaged fabric;
It should be understood that optionally the layers could be created in the reverse order depending upon the type of heat press equipment being used;
10. The imaged fabric is transferred to a laser cutting equipment and trimmed along the image outline 1 or 5 to obtain a high definition litho appliqué;
11. The high definition litho appliqué is transferred to an embroidery equipment where it is placed and aligned onto a garment, then stitched in place along stitching path 2 or 6;
12. Optionally, embroidery is added along path 4.

In order to produce an appliqué as shown in either FIG. 7 or 8, having a 300 dpi image within the word-art, the following steps are used:
13. A digital image having resolution greater than 300 dpi, such as from a camera, is brought into a computer program such as Adobe Illustrator;
14. A word-art mask in the form of the word VAIL 3 and having an outer border either in the shape of a rectangle 1 or outline of the word VAIL 5, is created in Adobe Illustrator, and applied to the digital image to produce a digital appliqué image having high-resolution image only inside the letters of the word VAIL 3;
15. The digital appliqué image is then processed by a computer program such as ONYX PosterShop in order to re-calibrate the colors to match the printer's capabilities, and optionally to create a numbered open series limited edition image, which is then printed onto thermal transfer paper using sublimation inks;
16. The digital appliqué image is also processed by another computer program to create digital computer files for laser cutting and optionally for embroidery;
17. A swatch of 100% sueded polyester satin microfiber sheet is then heated for 20-30 seconds at 300-350° F. on a heat transfer press to obtain a pre-shrunk swatch of 100% sueded polyester satin microfiber;
18. A swatch of high temperature non-woven fusible fabric is placed on a heat transfer press with the adhesive side up;
19. The pre-shrunk swatch of 100% sueded polyester satin microfiber sheet is placed on top of the high temperature non-woven fusible fabric;
20. The printed transfer paper is placed on top of the 100% sueded polyester satin microfiber sheet with the ink side of the transfer paper in contact with the 100% sueded polyester satin microfiber sheet;
21. Heat is applied at 400-425° F. for 20-25 seconds to obtain an imaged fabric which is highly resistant to dimensional distortion;
It should be understood that optionally the image could be heat transferred onto the 100% sueded polyester satin microfiber sheet in a first step, followed by the fusing of the high temperature non-woven fusible fabric onto the imaged 100% sueded polyester satin microfiber sheet in a second step to obtain the same imaged fabric;
It should be understood that optionally the layers could be created in the reverse order depending upon the type of heat press equipment being used;
22. The imaged fabric with thermo-adhesive film is transferred to a laser cutting equipment and trimmed along the image outline 1 or 5 to obtain a high definition litho appliqué;
23. The high definition litho appliqué is transferred to an embroidery equipment where it is placed and aligned onto a garment, then stitched in place along stitching path 2, or for stitching path 6, a first pass stitching along stitching path 7 in FIG. 3 followed by a second pass stitching along stitching path 8 in FIG. 4;
24. Optionally, embroidery is added along path 4.

In an alternate implementation to produce an appliqué as shown in FIG. 7, having a 300 dpi image within the word-art, the following steps are used:
25. The same process as described above in steps 13 through 17 is followed;
26. The pre-shrunk swatch of 100% sueded polyester satin microfiber sheet is placed on a heat press;
27. The printed transfer paper is placed on top of the 100% sueded polyester satin microfiber sheet with the ink side of the transfer paper in contact with the 100% sueded polyester satin microfiber sheet;
28. Heat is applied at 400-425° F. for 20-25 seconds to obtain an imaged fabric;
It should be understood that optionally the layers could be created in the reverse order depending upon the type of heat press equipment being used;
29. A sheet of thermo-adhesive film is tacked onto the non-imaged side of the imaged fabric by applying heat at 275-300° F. for 5 seconds so as to adhere the thermo-adhesive film to the imaged fabric while allowing the thermo-adhesive film to be re-heated in a subsequent step and fully adhered to both the imaged fabric and a garment;
30. The imaged fabric with thermo-adhesive film is transferred to a laser cutting equipment and trimmed along the image outline 1 to obtain a high definition litho appliqué;
31. The high definition litho appliqué is transferred to an embroidery equipment where it is placed and aligned onto a garment, then stitched in place along stitching path 2;
32. Optionally, embroidery is added along path 4;
33. The garment with high definition litho appliqué is then transferred to a heat press where heat is then applied at 275-300° F. for 10-15 sec to further affix the center portion of the appliqué to the garment, thereby preventing wrinkling of the appliqué independent of the garment.

Numerous modifications may be made without departing from the spirit and scope of the invention as defined in the appended claims.

What is claimed is:

1. A method of making a pliable high definition appliqué, comprising:
(i) digitally printing a high resolution image onto a transfer substrate using sublimation inks;
(ii) pre-heating a swatch of woven fabric made of twill or microfiber having a denier of less than 150 to obtain an image-ready pre-shrunk swatch of woven fabric; and
(iii) forming said image on said swatch by applying said transfer substrate under applied heat and pressure to a front side thereof so as to transfer said sublimation inks to said swatch; and
(iv) cutting out the image from the imaged fabric to obtain the high definition appliqué ready for stitching on to a garment; and
wherein a pliable stabilizing layer is applied under heat and pressure to a back side of said swatch to stabilize said image against dimensional distortion.

2. A method as claimed in claim 1, wherein the woven fabric is polyester twill yarn of 75 to 150 denier.

3. A method as claimed in claim 2, wherein said stabilizing layer is a non-woven fusible fabric.

4. A method as claimed in claim 3, wherein the non-woven fusible fabric is applied at a temperature of 400 to 425° F.

5. A method as claimed in claim 3, further comprising the step of stitching the appliqué to a garment.

6. A method as claimed in claim 1, wherein the woven fabric is microfiber polyester twill yarn of 20 to 75 denier.

7. A method as claimed in claim 6, wherein said stabilizing layer is a thermo-adhesive film.

8. A method as claimed in claim 7, wherein the thermo-adhesive film is applied at a temperature of 275-300° F.

9. A method as claimed in claim 7, further comprising the step of stitching the appliqué to a garment.

10. A method as claimed in claim 9, wherein after stitching heat and pressure is applied to the garment to affix the center portion of the appliqué, thereby preventing wrinkling.

11. A method as claimed in claim 1, wherein the appliqué ready for stitching to a garment is embroidered.

12. A method as claimed in claim 1, wherein the transfer substrate is paper.

13. An appliqué ready for stitching to a garment exhibiting a high resolution image made by the method set forth in claim 1.

14. An appliqué as claimed in claim 13, exhibiting an embroidered emblem.
